(19) United States
(12) Patent Application Publication
(10) Pub. No.: US 2019/0108442 A1
(43) Pub. Date: Apr. 11, 2019

(54) MACHINE LEARNING SYSTEM, MACHINE LEARNING METHOD AND NON-TRANSITORY COMPUTER READABLE MEDIUM FOR OPERATING THE SAME

(71) Applicant: HTC Corporation, Taoyuan City (TW)

(72) Inventors: Edward Chang, Taoyuan City (TW); Chun-Nan Chou, Taoyuan City (TW); Chun-Hsien Yu, Taoyuan City (TW)

(21) Appl. No.: 16/145,206

(22) Filed: Sep. 28, 2018

Related U.S. Application Data
(60) Provisional application No. 62/566,534, filed on Oct. 2, 2017.

(51) Int. Cl. G06N 3/08; G06N 20/00

(52) U.S. Cl. CPC G06N 3/08; G06N 20/00

(57) ABSTRACT

A machine learning system includes a memory and a processor. The processor is configured to access and execute at least one instruction from the memory to perform inputting raw data to a first partition of a neural network, in which the first partition at least comprises an activation function of the neural network. The activation function is applied to convert the raw data into irreversible metadata. The metadata is transmitted to a second partition of the neural network as inputs to generate a learning result corresponding to the raw data.

### CROSS-REFERENCE TO RELATED APPLICATION

This application claims priority to U.S. provisional Application Ser. No. 62/566,534, filed on Oct. 2, 2017, which is herein incorporated by reference.

### BACKGROUND

### Technical Field

The present disclosure relates to a computation system, a computation method and a non-transitory computer readable medium to perform computation. More particularly, the present disclosure relates to a computation system, a computation method and a non-transitory computer readable medium to perform machine learning tasks.

### Description of Related Art

In recent times, neural networks and deep learning processes have been widely used in various fields, such as visual recognition, audio recognition, machine translation, etc. However, when training samples of a learning process contain sensitive or private information, it is necessary to consider not only the accuracy of the learning process, but also the security of the training samples.

### SUMMARY

An aspect of present disclosure provides a machine learning system. The machine learning system comprises a memory and a processor. The processor is communicatively coupled to the memory. The memory is stored with at least one instruction. The processor is configured to access and execute at least one instruction from the memory to perform at least the step of inputting raw data to a first partition of a neural network, wherein the first partition at least comprises an activation function of the neural network, and the activation function is configured to convert the raw data into metadata which is irreversible, in which the metadata is transmitted to a second partition of the neural network to generate a learning result corresponding to the raw data.

Another aspect of present disclosure provides a machine learning method. The machine learning method is executed by a processor. The machine learning method comprises inputting raw data to a first partition of a neural network, wherein the first partition at least comprises an activation function of the neural network, and the activation function is configured to convert the raw data into metadata which is irreversible, in which the metadata is transmitted to a second partition of the neural network to generate a learning result corresponding to the raw data.

Still another aspect of present disclosure provides a non-transitory computer readable medium. The non-transitory computer readable medium is associated with at least one instruction that defines a machine learning method. The machine learning method comprises inputting raw data to a first partition of a neural network, wherein the first partition at least comprises an activation function of the neural network, and the activation function is configured to convert the raw data into metadata which is irreversible, in which the metadata is transmitted to a second partition of the neural network to generate a learning result corresponding to the raw data.

It is noted that the description above and the embodiments in the following paragraphs are merely examples for explaining the contents of the claims of the present disclosure.

### BRIEF DESCRIPTION OF THE DRAWINGS

The present disclosure can be more fully understood by reading the following detailed description of the embodiments, with reference made to the accompanying drawings as follows:

FIG. 1 is a schematic diagram of a machine learning system according to an embodiment of the present disclosure.

FIG. 2 is a flow chart showing a machine learning method according to an embodiment of the present disclosure.

FIG. 3 is a graph showing a contrast between a conventional sigmoid and a stepwise sigmoid according to an embodiment of the present disclosure.

FIG. 4A is a diagram showing a neural network according to an embodiment of the present disclosure.

FIG. 4B is a diagram showing the neural network according to an embodiment of the present disclosure

FIG. 5A is a diagram showing some raw images according to an embodiment of the present disclosure.

FIG. 5B is a diagram showing some reversed images according to an embodiment of the conventional art.

FIG. 5C is a diagram showing some reversed images according to an embodiment of the present disclosure.

FIG. 6A is a diagram showing some raw images according to an embodiment of the present disclosure.

FIG. 6B is a diagram showing some reversed images according to an embodiment of the conventional art.

FIG. 6C is a diagram showing some reversed images according to an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

As used herein, the terms “comprising,” “including,” “having,” and the like are to be understood to be open-ended, i.e., to mean including but not limited to.

As used herein, the term “and/or” includes any and all combinations of one or more of the associated listed items.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

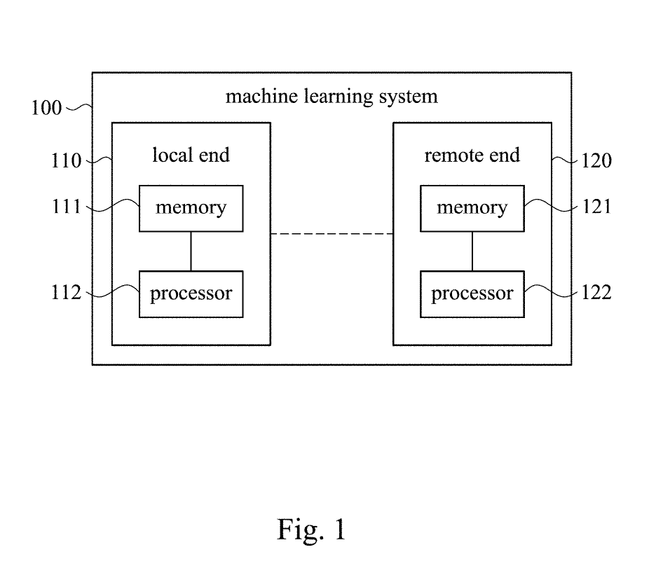

FIG. 1 is a schematic diagram of a machine learning system according to an embodiment of the present disclosure. As shown in FIG. 1, in some embodiments, a machine learning system 100 can include a local end 110, which for example can be a local server or an independent computer. The local end 110 at least includes a memory 111 and a processor 112. In some embodiments, the memory 111 is communicatively coupled to the processor 112.

In some embodiments, the memory 111 can be a flash memory, a HDD, a SSD (Solid State Disk), a DRAM (Dynamic Random Access Memory) or a SRAM (Static Random-Access Memory). In some embodiments, the memory 111 can be a non-transitory computer readable medium stored with at least one instruction associated with a machine learning method. The at least one instruction can be accessed and executed by the processor 112.

In some embodiments, the processor 112 can be, but is not limited to being, a single processor or an integration of multiple microprocessors such as CPUs or GPUs. The microprocessors are electrically coupled to the memory 111 in order to access the at least one instruction. According to the at least one instruction, the above-mentioned machine learning method can be performed. For better understanding, details of the machine learning method will be described in the following paragraphs.

In some embodiments, the machine learning system 100 can further include a remote end 120, which for example can be a cloud server or an independent computer. The remote end 120 at least includes a memory 121 and a processor 122. In some embodiments, the memory 121 is communicatively coupled to the processor 122. It is noted that the configuration and the functions of the memory 121 and the processor 122 are similar to those of the memory 111 and the processor 112 of the local end 110 described above. Therefore, an explanation of the configuration and the functions thereof will not be repeated.

In some embodiments, the local end 110 and the remote end 120 are communicatively coupled in the machine learning system 100. It is noted that the communicative coupling can be physical or non-physical. For instance, in some embodiments, the local end 110 and the remote end 120 can be coupled via a Wi-Fi connection. In some embodiments, the local end 110 and the remote end 120 can be coupled via a cable connection. In these embodiments, the local end 110 and the remote end 120 can realize bidirectional information exchange via the connections.

In some embodiments, the local end 110 can be disposed in organizations that store data with sensitive information, such as hospitals, military institutions or semiconductor industries. In some embodiments, the remote end 120 can be disposed in organizations that possess advanced computation capabilities, such as computation platforms or cloud service providers. In some embodiments, the remote end 120 outperforms the local end 110 with respect to computation capabilities. However, the present disclosure is not limited thereto.

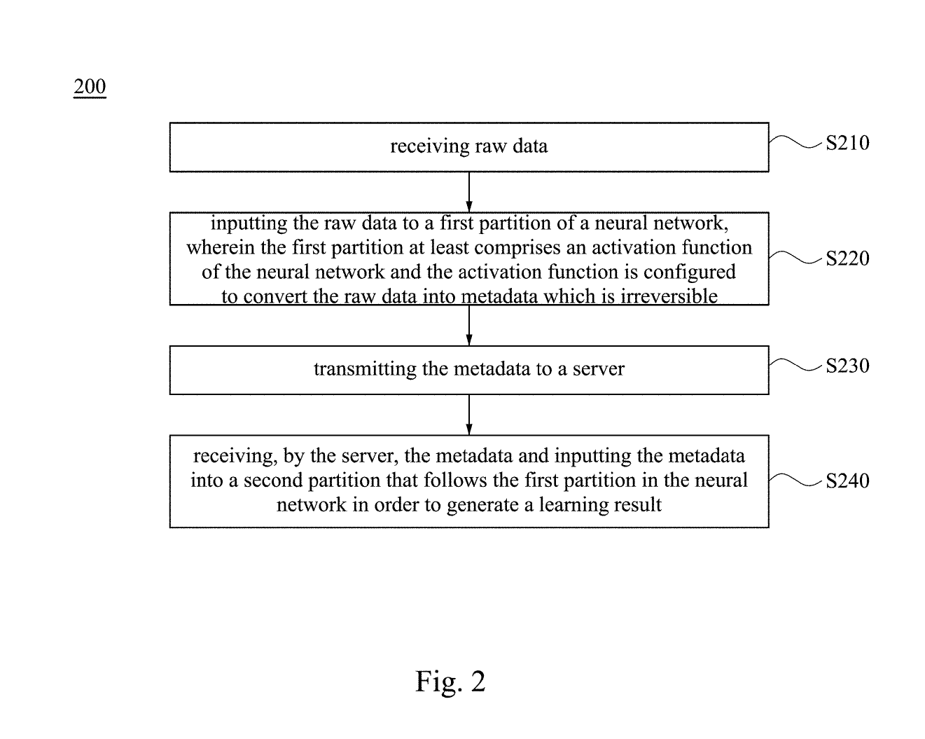

FIG. 2 is a flow chart showing a machine learning method according to an embodiment of the present disclosure. As shown in FIG. 2, in some embodiments, a machine learning method 200 can be performed by the processor 112 of the local end 110 shown in FIG. 1. In some embodiments, the machine learning method 200 can be performed by the processor 112 of the local end 110 in cooperation with the processor 122 of the remote end 120 shown in FIG. 1. Details of the machine learning method 200 in accordance with some embodiments are described in the paragraphs below.

Step S210: receiving raw data.

In some embodiments, the processor 112 of the local end 110 can access at least one raw data from a memory (e.g., the memory 111). In some embodiments, the at least one raw data corresponds to image information. In some embodiments, the at least one raw data corresponds to voice information or text information. However, data formats being applied in the present disclosure are not limited thereto.

For instance, in some embodiments, the local end 110 corresponds to a hospital and the processor 112 of the local end 110 is communicatively coupled to databases of the hospital. Medical image data, such as X-ray images, tissue section images, or MRI (Magnetic Resonance Imaging) images, collected from patients in the hospital are stored in the databases of the hospital. In some embodiments, the at least one raw data accessed or received by the processor 112 can be the above-mentioned X-ray images, tissue section images, or MRI images.

In some embodiments, the memory 111 and the processor 112 of the local end 110 are disposed in the hospital which is a secured end. That is, information security of the local end 110 and the hospital can be ensured.

Step S220: inputting the raw data to a first partition of a neural network, wherein the first partition at least comprises an activation function of the neural network and the activation function is configured to convert the raw data into metadata which is irreversible.

In some embodiments, after the processor 112 accesses or receives the at least one raw data, the at least one raw data can be inputted to a first partition of a neural network. It is noted that the neural network (i.e., the neural network NN in the following paragraphs) and the first partition (i.e., the first partition PT1 in the following paragraphs) will be described in detail below.

It is to be understood that the aforementioned neural network can be a model applied in a machine learning process. The neural network can include a plurality of layers arranged in a specific order and each layer can include a plurality of neurons. In general, the plurality of neurons in these layers can receive inputs and generate outputs. In this manner, each of the neurons can apply a specific calculation corresponding to the layer where it is located.

In some embodiments, the neural network can be a convolutional neural network used in a deep learning process. In some embodiments, the neural network can include some computation layers such as convolution layers, activation functions, polling layers, fully connected layers, etc.

For example, in some embodiments, the convolution layers are arranged with some specific filters. With these filters, convolution calculation can be applied to the inputs of these layers to extract some features. For example, in some embodiments, the activation functions can be arranged next to the convolution layers. The activation functions can apply a nonlinear filtering calculation to the outputs of the convolution layers. In some embodiments, the activation functions can, but not limited to, transform the outputs of the convolution layers into positives. For example, in some embodiments, the pooling layers can be arranged to apply aggregation calculations to the inputs, such as maximum or average calculation. Through the pooling layers, noises in the inputs can be eliminated and features can be further extracted. For example, in some embodiments, neurons in the fully connected layers can be arranged to apply matrix multiplications to the inputs based on some weights corresponding to the neurons to obtain outputs. The outputs can be associated to a learning result of the neural network.

In some embodiments, the neural network includes the convolution layers, the activation functions, the pooling layers and the fully connected layers arranged in a specific order. In this manner, the neurons of these layers can be connected with each other. According to the order of these layers and the connections among these neurons, the at least one raw data can be inputted to the neural network as training samples so that the at least one raw data can be calculated by these layers to obtain the learning result. In some embodiments, the neural network can run a plurality of gradient computations to train/modify the features being extracted by the convolution layers and the pooling layers and to train/modify the weights of the fully connected layers in a gradual manner. In such way, a machine learning process/deep learning process based on the neural network can be established.

In some embodiments, the first partition of the neural network at least includes an activation function configured to transform the at least one raw data into irreversible metadata. It is noted that the meaning of the term “irreversible” will be explained in detail in the paragraphs below.

In some embodiments, the aforementioned activation function of the present disclosure can be a stepwise nonlinear function. It is to be understood that there are some conventional activation functions that are widely used in this field, such as sigmoid, hyperbolic tangent or rectified linear unit (ReLU). However, in contrast with these conventional activation functions, a graph of the activation function of the present disclosure shows that a domain of the activation function is substantially divided into multiple intervals and each interval is presented with a step line. Therefore, it is shown that the graph of the activation function of the present disclosure is actually an integration of multiple step line segments. That is, the activation function of the present disclosure can alter the conventional sigmoid, hyperbolic tangent or ReLU into a stepwise form.

For instance, in some embodiments, the activation function of the present disclosure can be a stepwise sigmoid. In contrast with the conventional sigmoid, a graph of the stepwise sigmoid can be presented as an integration of multiple step line segments.

For example, in some embodiments, a function formula of the stepwise sigmoid is shown below (i.e., the g^{step}(x)).

$${g}^{step} ( x ) = g ( sign ( x ) \times ⌊ \frac{min ( \vert x \vert , v )}{v / n} ⌋ \times \frac{v}{n} )$$

In the formula above, “└ ┘” represents a floor function. For example, in the case of “└a┘”, the input of the function is “a”, and the output of the function is the first or greatest integer less than or equal to “a”.

In the formula above, “min( )” represents a min (minimum) function. For example, in the case of “min(b, c)”, the inputs of the function are “b” and “c”, and the output of the function is the minimum one of “b” and “c”.

In the formula above, “| |” represents an absolute value function. For example, in the case of “|d|”, the input of the function is “d”. If “d” is non-negative, the output of the function is “d”, whereas if “d” is negative, the output of the function is “−d”.

In the formula above, “sign( )” represents a step function having only two outputs. For example, in the case of “sign(e)”, the input of the function is “e”. If “e” is non-negative, the output of the function is “1”, whereas if “e” is negative, the output of the function is “−1”.

In the formula above, “n” represents a number of the intervals that the domain of the stepwise sigmoid is divided.

In the formula above, “v” represents a clipping value, which is a fixed value settled for division in the stepwise sigmoid.

In the formula above, “x” represents an input to the functions, which is a value in the domain of the stepwise sigmoid.

Basically, the calculation of the above stepwise sigmoid is as explained in the sentences that follow. In this case, “x” is an input of the stepwise sigmoid function. A comparison between the absolute value of “x” and “v” can be established and the minimum one is selected as a first value. Next, the first value can be divided by a ratio of “v” and “n” to obtain a second value, and a third value which is the first integer less than or equal to the second value can be found. The third value is multiplied by the ratio of “v” and “n” to obtain a fourth value. According to the positive or negative sign of “x”, the function can multiply the fourth value by “1” or “−1” to get a fifth value. The fifth value can be inputted to the sigmoid to obtain an output corresponding to “x”.

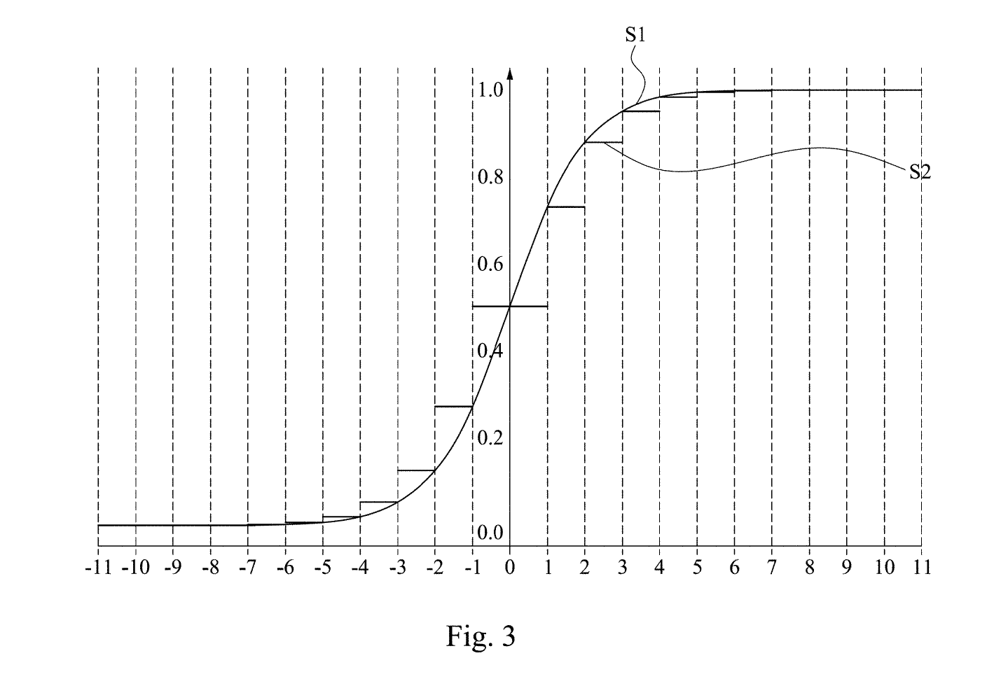

For better understanding, reference can be made to FIG. 3. FIG. 3 is a graph showing a contrast between a conventional sigmoid and a stepwise sigmoid according to an embodiment of the present disclosure. In some embodiments, the horizontal axis in FIG. 3 represents the values of “x” corresponding to a domain of both the conventional sigmoid and the stepwise sigmoid. The vertical axis in FIG. 3 represents the values of “g(x)” and “g^{step}(x)”, in which the values of g(x) are corresponding to a range of the conventional sigmoid and the values of g^{step}(x) are corresponding to a range of the stepwise sigmoid of present disclosure.

As shown in FIG. 3, in the same domain (i.e., values of x from −10 to 10), the range of the conventional sigmoid (i.e., values of g(x) from 0.0 to 1.0) forms a curve S1 but the range of the stepwise sigmoid (i.e., values of g^{step}(x) from 0.0 to 1.0) forms a stepwise line S2. It is shown in the figure that the stepwise line S2 is a combination of multiple horizontal step lines along the divided intervals.

As shown in FIG. 3, the curve S1 corresponding to the conventional sigmoid is an exponential curve that gradually grows when x increases. It is noted that the formula of the conventional sigmoid in this embodiment can be presented as “g(x)=1/(1+e^{-x})”. In the formula, “e” represents an exponential function with a base of Euler's number.

As shown in FIG. 3, the stepwise line S2 corresponds to the stepwise sigmoid formed by multiple step lines. When x increases, the corresponding step line goes higher. With respect to the formula of the stepwise sigmoid in this embodiment, reference can be made to the stepwise sigmoid mentioned above. In the embodiment, “v” (i.e., the clipping value) of g^{step}(x) is 10 and “n” (i.e., the number of intervals) is 21.

As shown in FIG. 3, according to the trend of the curve S1 it is known that, within the entire interval of the conventional sigmoid, each value of “g(x)” is corresponding to one value of “x”. However, according to the trend of the stepwise line S2 it is shown that, within the divided intervals of the stepwise sigmoid, each value of “g^{step}(x)” can be possibly correspond to more than one value of “x”.

It is noted that the stepwise sigmoid shown in FIG. 3 is merely an example of the present disclosure rather a limitation. In some embodiments, the number of the intervals that the domain is divided and the clipping value can be different so that the computations can vary based on the difference. In some embodiments, the stepwise sigmoid in FIG. 3 can be considered as an exemplary embodiment, the stepwise nonlinear function of the present disclosure can be applied to a conventional hyperbolic tangent or a conventional ReLU. That is, according to the functions above, inputs (i.e. “x”) can be transformed in the same way. The transformed inputs can be inputted to the hyperbolic tangent or the ReLU so that a stepwise hyperbolic tangent or a stepwise ReLU can be obtained.

In some embodiments, according to the activation function (i.e., the stepwise sigmoid above) in the first partition, the processor 112 can transform the at least one raw data into the metadata. The metadata is a type of intermediate data.

In some embodiments, the processor 112 can transform the at least one raw data into the metadata according to the stepwise sigmoid shown in FIG. 3. As mentioned above, in the divided intervals corresponding to the stepwise sigmoid, each g^{step}(x) value (which is the metadata) corresponds to more than one “x” value. Therefore, if inputting the metadata into an inverse function, a many-to-one mapping can lead to an irreversible situation of the metadata. More specifically, the irreversible situation herein refers to a situation in which one output of the stepwise sigmoid corresponds to a number of possible inputs so that there is no certainty the metadata can be reversed to the original at least one raw data.

In some embodiments, even if the logic of the stepwise sigmoid is known, it is still difficult to effectively conduct an inverse function that can mathematically obtain the original at least one raw data from the metadata.

It is to be understood that the foregoing stepwise sigmoid is merely an example and the present disclosure is not limited thereto. In some embodiments, the processor 112 can transform the at least one raw data into the metadata according to other available activation functions. As long as the generated metadata cannot be efficiently reversed to the at least one raw data due to many-to-one mapping difficulties, the activation functions are covered by the scope of the present disclosure.

Step S230: transmitting the metadata to a server.

In some embodiments, after the processor 112 transforms the at least one raw data into the metadata via the activation function in the first partition, the processor 112 can transmit the metadata to the remote end 120 through a communication link. In some embodiments, the memory 121 and the processor 122 of the remote end 120 are located at a cloud service provider.

Step S240: receiving, by the server, the metadata and inputting the metadata into a second partition that follows the first partition in the neural network in order to generate a learning result.

In some embodiments, the processor 112 can transmit the metadata to the remote end 120 through the communication link. The processor 122 of the remote end 120 can receive the metadata and store the metadata in the memory 121. Alternatively, the processor 122 can input the metadata into a second partition of the neural network. Through the computations of the second partition, the processor 122 can generate a learning result corresponding to the at least one raw data. It is noted that the neural network (i.e., the neural network NN in the following paragraphs) and the second partition (i.e., the second partition PT2 in the following paragraphs) will be described in detail below.

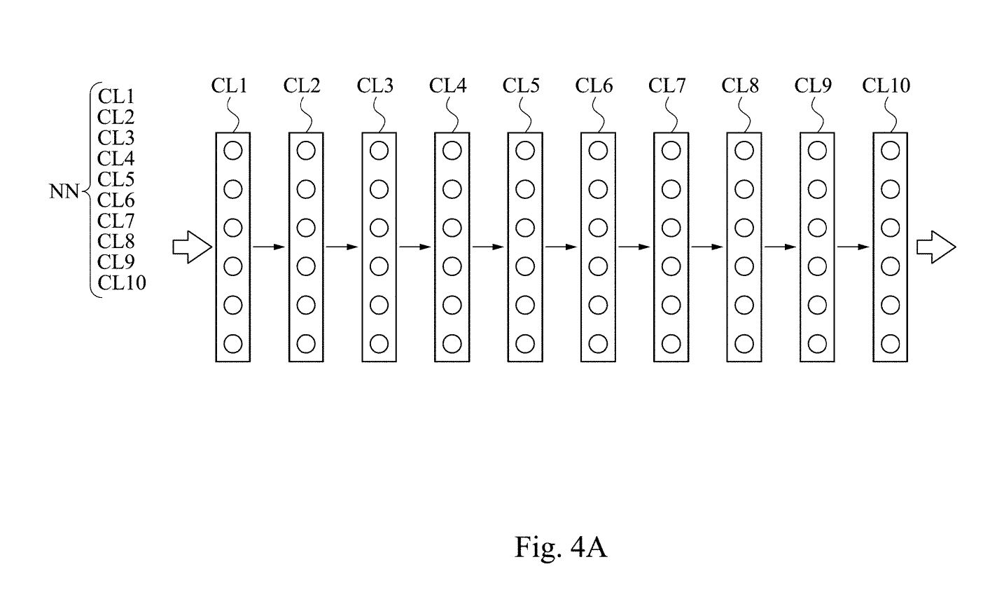

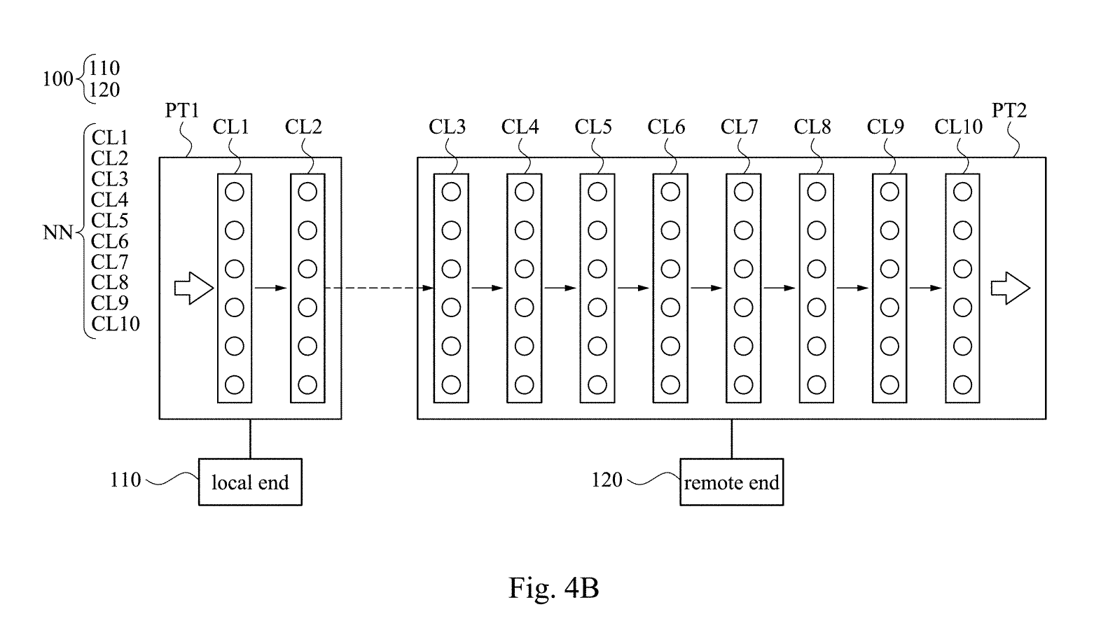

For a better understanding of the first partition and the second partition, reference is made to FIG. 4A and the FIG. 4B. FIG. 4A and the FIG. 4B are both diagrams showing the neural network according to an embodiment of present disclosure.

In one embodiment, as shown in FIG. 4A, the neural network NN can include a plurality of computation layers. The computation layer CL1 can be a first convolution layer. The computation layer CL2 can be a first activation function. The computation layer CL3 can be a second convolution layer. The computation layer CL4 can be a second activation function. The computation layer CL5 can be a first pooling layer. The computation layer CL6 can be a third convolution layer. The computation layer CL7 can be a third activation function. The computation layer CL8 can be a second pooling layer. The computation layer CL9 can be a first fully connected layer. The computation layer CL10 can be a second fully connected layer. The neural network NN is formed by the computation layers CL1-CL10.

In one embodiment, the neural network NN can be used as a training model of the machine learning system 100. In one embodiment, the input of the machine learning system 100 (i.e., the at least one raw data) can be inputted to the computation layer CL1 and calculated by the computation layer CL1 to obtain an output. The output of the computation layer CL1 can be inputted to the computation layer CL2 and calculated by the computation layer CL2 to obtain an output. In a similar manner, the computation layer CL10 can generate an output. The output of the computation layer CL10 is a determination result of the neural network NN, which is also the learning result of the neural network NN.

Referring to FIG. 4B. It is noted that the local end 110 and the remote end 120 shown in the embodiment of FIG. 4B are the same as the local end 110 and the remote end 120 shown in the embodiment of FIG. 1. FIG. 4B is presented in order to explain one first partition PT1 and one second partition PT2 of the neural network NN.

As shown FIG. 4B, the neural network NN can include the first partition PT1 and the second partition PT2.

In some embodiments, the computation layers CL1-CL2 of the neural network NN are arranged in the first partition PT1. In such embodiments, processes corresponding to the first partition PT1 of the neural network NN can be executed by the processor 112 of the local end 110.

In some embodiments, the computation layers CL3-CL10 of the neural network NN are arranged in the second partition PT2. In such embodiments, processes corresponding to the second partition PT2 of the neural network NN can be executed by the processor 122 of the remote end 120.

That is, as shown in FIG. 4B, in some embodiments, the neural network NN can be at least divided into two partitions, and each partition is processed by one of the local end 110 and the remote end 120.

Reference is made to FIG. 4A and FIG. 4B. As shown in the embodiment of FIG. 4A, the neural network NN includes multiple nonlinear activation functions, which are arranged at the computation layers CL2, CL4, CL7. As shown in FIG. 4B, in some embodiments, the first partition PT1 includes the computation layer CL2, and the computation layer CL2 is arranged with the first activation function. That is, in some embodiments, the aforementioned activation function is the activation function that is ordered first in the neural network NN.

As shown in FIG. 4B, in some embodiments, the first partition PT1 further includes the computation layer CL1, and the computation layer CL1 is arranged with the first convolution function. In some embodiments, the processor 112 can input the at least one data into the computation layer CL1 to obtain convolution outputs, and the outputs can be inputted to the computation layer CL2. The first activation function arranged at the computation layer CL2 can transform the outputs to the metadata.

As shown in FIG. 4B, in some embodiments, the processor 112 can transmit the metadata to the remote end 120. The processor 122 of the remote end 120 can execute the computation layers CL3-CL10 to obtain the learning result of the neural network NN. In some embodiments, the computation layer CL4 and computation layer CL7 are arranged with some activation functions such as sigmoid, hyperbolic tangent or ReLU.

It is noted that the neural network NN shown in FIG. 4A and FIG. 4B are merely examples, and the scope of present disclosure is not limited thereto. In some embodiments, the neural network NN can include different numbers of computation layers arranged in different orders. The first partition PT1 and the second partition PT2 can include different numbers of computation layers as well.

As mentioned above, in some embodiments, the at least one raw data accessed/received by the processor 112 can be some private images, such as X-ray images, tissue section images, or MRI images. In a conventional approach, the at least one raw data would be transmitted out of the hospital without protections. In this case, if the transmission is unsafe, a malicious third party can intercept the at least one raw data during transmission.

In another case, even if the at least one raw data is transformed via a conventional activation function in advance, the transformed data can still be reversed to the original at least one raw data. It is noted that the conventional activation function includes, but is not limited to including, sigmoid, hyperbolic tangent, ReLU, etc.

In some embodiments (e.g., FIG. 3), a function formula of the conventional sigmoid can be presented as sigmoid(z)=1/(1+e^{-z}). In the formula, “e” represents an exponential function with a base of Euler's number. In some embodiments, metadata being transformed by the conventional sigmoid can be reversed to the raw data according to a known inverse function. A function formula of the known inverse function can be presented as z=sigmoid⁻¹(y)=−ln((1/y)−1). In the formula, “ln( )” represents a natural logarithm function.

In some embodiments, a function formula of the conventional hyperbolic tangent can be presented as tan h(z)=(e^{2z}−1)/(e^{2z}+1). In the formula, “e” represents an exponential function with a base of Euler's number. In some embodiments, metadata being transformed by the conventional hyperbolic tangent can be reversed to the raw data according to a known inverse function. A function formula of the known inverse function can be presented as tan h⁻¹(z)=[ln(1+z)−ln(1−z)]/2. In the formula, “ln( )” represents a natural logarithm function.

In some embodiments, a function formula of the conventional ReLU can be presented as ReLU(z)={z, if z≥0; 0, otherwise}. In the formula, if input z is greater than or equal to 0, an output of the function is z, whereas if input z is less than 0, the output of the function is 0. If a malicious third party intercepts the metadata, the positive values in the metadata can be used. Once the negative values in the metadata are solved, the at least one raw data is gained. Moreover, it is noted that, with the metadata transformed via the conventional ReLU, the positive values in the metadata can provide sufficient information visually recognizable as the at least one raw data.

In contrast, in some embodiments of the present disclosure, the processor 112 can transform the at least one raw data into the metadata according to said stepwise sigmoid, and there is no efficient way to find an inverse function for the stepwise sigmoid of the present disclosure.

In some embodiments, if a malicious third party still tries to reverse the metadata according to their reverse functions, the reversed results are not visually recognizable as the at least one raw data due to the transformation of the stepwise sigmoid. That is, it is less likely for the reversed result to be recognized as the X-ray images, the tissue section images, or the MRI images.

Efficiencies of the present disclosure and the conventional arts are described in the following paragraphs.

In some embodiments, a machine learning system can be built according to a conventional sigmoid. In an experiment in which such a system is used to run stochastic gradient descending computation for 90 epochs, with training samples (i.e., the at least one raw data) from the MNIST (Mixed National Institute of Standards and Technology) database, a learning accuracy of 99.68% can be achieved. In the embodiment, the training samples obtained from the MNIST database include images of a plurality of handwritten numbers. It is noted that these images of handwritten numbers can be accessed on professor LeCun's website (http://yann.lecun.com/exdb/mnist/).

In some embodiments, the machine learning system can be built according to a conventional sigmoid. In an experiment in which such a system is used to run stochastic gradient descending computation for 90 epochs, with training samples (i.e., the at least one raw data) from the CIFAR10 database, a learning accuracy of 86.94% can be achieved. In the embodiment, the training samples obtained from the CIFAR10 database include images related to 10 categories of objects, such as images of airplanes, cars, birds, cats, deer, dogs, frogs, boats, trucks, etc. It is noted that these images of objects can be accessed on the following website (http://www.cs.toronto.edu/˜kriz/cifar.html).

In some embodiments, a machine learning system can be built according to the stepwise sigmoid of present disclosure. In an experiment in which such a system is used to run stochastic gradient descending computation for 90 epochs, with the same training samples (i.e., the at least one raw data) from the MNIST database, the following learning accuracies can be achieved. In the case in which “n” (i.e., the number of domain divisions of the stepwise sigmoid) is 1, a learning accuracy of 10.28% can be achieved. In another case in which “n” is 5, a learning accuracy of 23.27% can be achieved. In another case in which “n” is 11, a learning accuracy of 99.57% can be achieved. In still another case in which “n” is 21, a learning accuracy of 99.65% can be achieved. As is evident, the learning accuracy grows when a larger “n” is applied. In the case in which “n” is 21, the learning accuracy of the present disclosure is almost the same as the learning accuracy of the conventional art.

In some embodiments, the machine learning system can be built according to the stepwise sigmoid of present disclosure. In an experiment in which such a system is used to run stochastic gradient descending computation for 90 epochs, with the same training samples (i.e., the at least one raw data) from the CIFAR10 database, the following learning accuracies can be achieved. In the case in which “n” (i.e., the number of domain divisions of the stepwise sigmoid) is 1, a learning accuracy of 13.74% can be achieved. In another case in which “n” is 5, a learning accuracy of 23.45% can be achieved. In another case in which “n” is 11, a learning accuracy of 49.91% can be achieved. In still another case in which “n” is 21, a learning accuracy of 81.28% can be achieved. As is evident, the learning accuracy grows when a larger “n” is applied. In the case in which “n” is 21, the learning accuracy of present disclosure is close to the learning accuracy of the conventional art.

As is evident, it can be anticipated that the machine learning system of the present disclosure can achieve a learning accuracy equivalent to the conventional art if a larger “n” is applied. Moreover, the learning accuracy would come to a fixed value when “n” is large enough. That is, “n” of the stepwise nonlinear function can be arranged from a first value to a second value, such as from 5-21.

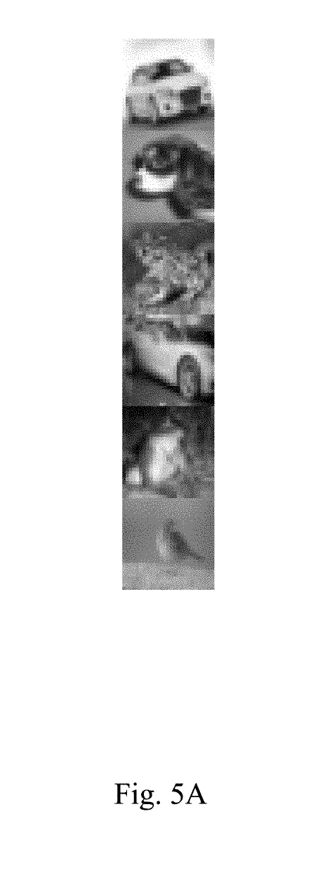

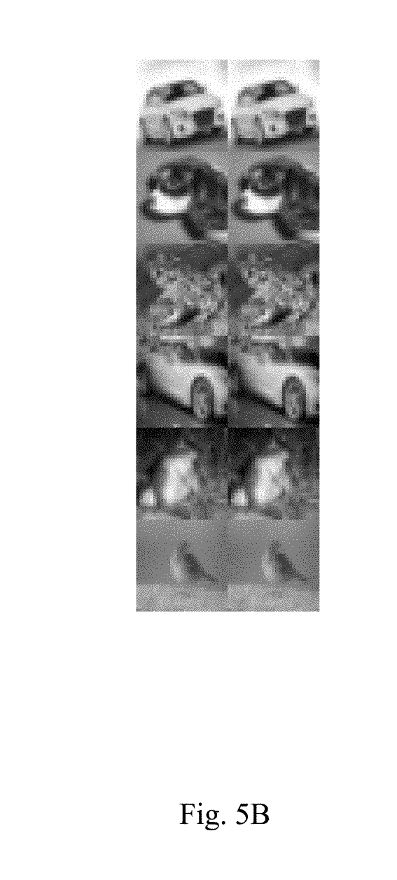

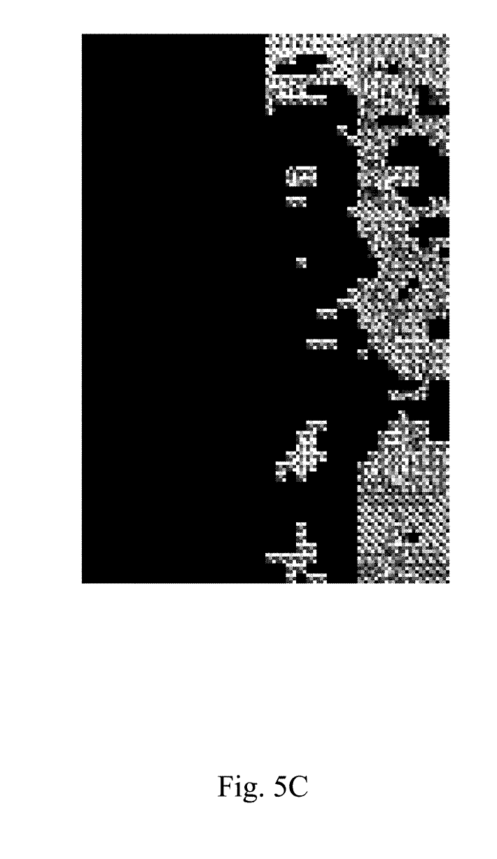

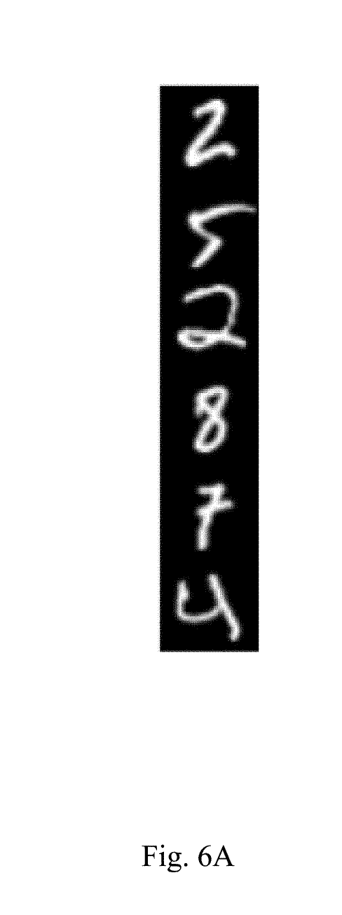

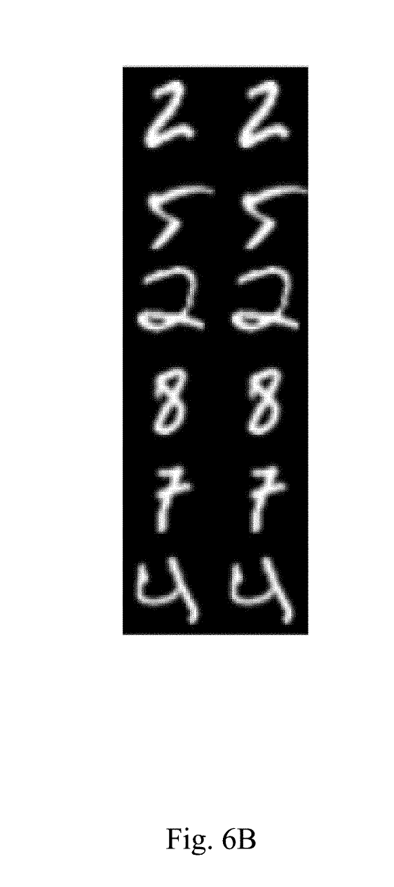

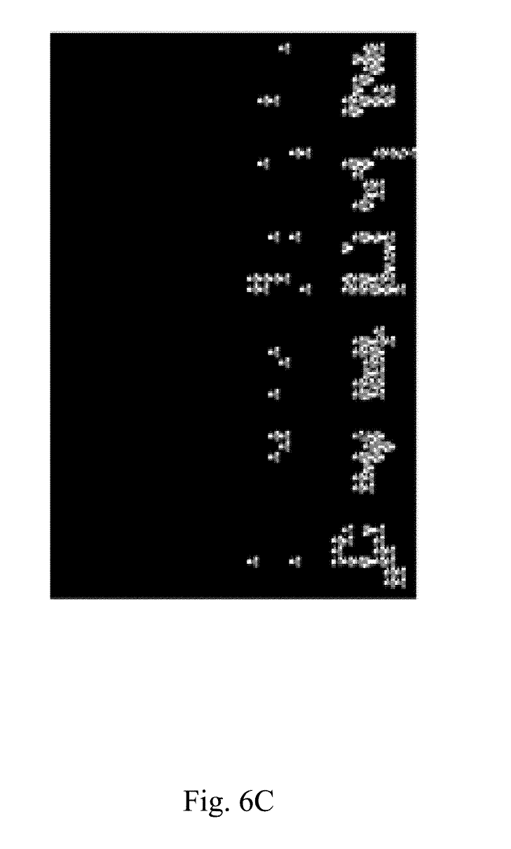

For better understanding, reference is made to FIGS. 5A-5C and FIGS. 6A-6C.

FIG. 5A is a diagram showing some raw images according to an embodiment of the present disclosure. As shown in FIG. 5A, there are six raw images aligned in a column. It is noted that these raw images of six objects are obtained from the CIFAR10 database mentioned above. The raw images are of a car, a dog, a frog, another car, another frog, and a bird.

FIG. 5B is a diagram showing some reversed images according to an embodiment of the conventional art. It is to be understood that the two columns of reversed images shown in FIG. 5B correspond to the column of raw images shown in FIG. 5A. The left column in FIG. 5B shows some reversed images. These reversed images represent the raw images in FIG. 5A being transformed to the metadata by the conventional sigmoid and then being reversed by the reverse function of the conventional sigmoid. The right column in FIG. 5B also shows some reversed images. These reversed images represent the raw images in FIG. 5A being transformed to the metadata by the conventional ReLU and then being reversed by the reverse function of the conventional ReLU. As shown in FIG. 5B, the objects in the images reversed and processed by the conventional activation function can be clearly recognized as those in the raw images shown in FIG. 5A.

FIG. 5C is a diagram showing some reversed images according to an embodiment of present disclosure. It is to be understood that the reversed images shown in FIG. 5C correspond to the raw images shown in FIG. 5A. These four columns of images show the reversed results that the raw images in FIG. 5A being transformed to the metadata by the stepwise sigmoid and then being reversed by the reverse function of the stepwise sigmoid. In a left-to-right order, the four columns of images in FIG. 5C are corresponding to the cases that “n” of the stepwise sigmoid being selected as 3, 5, 11, and 21, respectively. As shown in the figure, even in the case where “n” is selected as 21, the objects in the reversed images cannot be visually recognized as they were in the raw images (that is, this is what is referred to as “irreversible”). However, according to the embodiments above, the case where “n” is selected as 21 can achieve a learning accuracy of 81.28%.

FIG. 6A is a diagram showing some raw images according to an embodiment of present disclosure. As shown in FIG. 6A, there are multiple raw images of handwritten numbers being aligned in a vertical direction. It is noted that these raw images are obtained from the MNIST database mentioned above. The six raw images are of numbers 2, 5, 2, 8, 7 and 4, respectively.

FIG. 6B is a diagram showing some reversed images according to some embodiments of the conventional art. It is to be understood that the two columns of reversed images shown in FIG. 6B correspond to the column of raw images shown in FIG. 6A. The left column in FIG. 6B shows some reversed images that are reversed from metadata processed by the conventional sigmoid. The right column in FIG. 6B shows some reversed images that are reversed from metadata processed by the conventional ReLU. As shown in FIG. 6B, the numbers in the reversed images can be clearly recognized as the numbers in the raw images shown in FIG. 6A.

FIG. 6C is a diagram showing some reversed images according to some embodiments of present disclosure. It is to be understood that the four columns of reversed images shown in FIG. 6C correspond to the column of raw images shown in FIG. 6A. These four columns of reversed images show the reversed results that the raw images in FIG. 6A being transformed to the metadata by the stepwise sigmoid and then being reversed by the reverse function of the stepwise sigmoid. In a left-to-right order, the four columns of images in FIG. 6C are corresponding to the cases that “n” of the stepwise sigmoid being selected as 3, 5, 11, and 21, respectively. As shown in the figure, in the case where “n” is selected as 11, the numbers in the reversed images cannot be visually recognized as the numbers in the raw images (that is, this is what is referred to as “irreversible”). Moreover, according to the embodiments above, the case where “n” is selected as 11 can still achieve a learning accuracy of 99.57%.

Therefore, according to the above embodiments with different types of raw data, it is evident that a selection of “n” can influence both the learning accuracies and the possibilities that the reversed images can be recognized as objects in the raw images. Generally, a complexity of images with respect to text-based contents can be considered to be lower than a complexity of images with respect to object-based contents. Therefore, a smaller “n” can be selected when the raw images are text images and a larger “n” can be selected when the raw images are object images. Therefore, it is noted that, in some embodiments, different content complexities of the at least one raw data (e.g., texts or objects) can lead to different selections of “n” in the stepwise nonlinear function.

According to the above comparisons, it is evident that the present disclosure can obtain an accuracy that is closed to that of the conventional art. However, if the metadata generated according to the conventional art is intercepted, visually recognizable raw data can be obtained with known inverse functions. In contrast, if the metadata generated according to present disclosure is intercepted, the reversed data cannot be recognized as the original raw data. That is, present disclosure provides an approach to ensure both the accuracy of learning and the privacy of the metadata.

Though embodiments above are applied to a hospital and a cloud service provider, the scope of present disclosure is not limited thereto. The local end 110 of the machine learning system 100 and the remote end 120 of the machine learning system 100 can be applied to different terminals in other networks.

According to the embodiments above, the present disclosure provides the machine learning system, the machine learning method and the non-transitory computer readable medium for operating the same. In these embodiments, the neural network is separated into different partitions and run by different ends. As a result, a reduction in computation resources is realized.

In some cases, the present disclosure can also be applied to multiple local ends. In this case, one remote end can provide service to all these local ends in parallel. As a result, an efficient machine learning structure is provided.

It is also noted that the neural network division of the first partition and the second partition can raise security levels since it is more difficult to hack both the local end and the remote end to get the complete neural network.

Moreover, in the system of the present disclosure, if the metadata is leaked in the transmission from the local end to the remote end, or if the metadata is hacked at the remote end, the metadata cannot be recognized as the raw data. That is, the present disclosure can be used to prevent a black-box attack.

Additionally, in the system of the present disclosure, if the metadata stored at the local end are leaked and the computation layers corresponding to the local end are also leaked, the attacker still cannot reverse the metadata to the raw data. That is, the present disclosure can be used to prevent a white-box attack.

According to the foregoing embodiments, present disclosure provides efficient machine learning system, machine learning method and non-transitory computer readable medium under the situation of the sensitive information being confidential.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A machine learning system, comprising:
a memory storing at least one instruction;
a processor communicatively coupled to the memory, wherein the processor is configured to access and execute at least one instruction from the memory for:
inputting raw data to a first partition of a neural network, wherein the first partition at least comprises an activation function of the neural network and the activation function is configured to convert the raw data into irreversible metadata, and the metadata is transmitted to a second partition of the neural network to generate a learning result corresponding to the raw data.

2. The machine learning system of claim 1, further comprising:
a server communicatively coupled to the processor, wherein the server is configured to receive the metadata and input the metadata to the second partition that follows the first partition in the neural network.

3. The machine learning system of claim 1, wherein the activation function is ordered as a first activation function in the neural network.

4. The machine learning system of claim 1, wherein the activation function corresponds to a stepwise nonlinear function and a domain of the activation function is divided into a plurality of intervals according to a number of division, and each of the plurality of intervals corresponds to a fixed value in a range of the activation function.

5. The machine learning system of claim 4, wherein the activation function corresponds to a clipping value, and the clipping value and the number of division have a ratio, the activation function is configured to compare an input with the clipping value to generate a comparison result, and the activation function is configured to generate the metadata according to the ratio, the comparison result and the input.

6. The machine learning system of claim 4, wherein the number of division is in a range between a first value and a second value.

7. The machine learning system of claim 4, wherein the number of division is determined according to a content complexity of the raw data.

8. The machine learning system of claim 1, wherein the first partition comprises a convolution layer.

9. The machine learning system of claim 1, wherein the second partition comprises at least one of a convolution layer, a pooling layer and a fully connected layer.

10. A machine learning method executed by a processor, the machine learning method comprising:
inputting raw data to a first partition of a neural network, wherein the first partition at least comprises an activation function of the neural network and the activation function is configured to convert the raw data into irreversible metadata, and the metadata is transmitted to a second partition of the neural network to generate a learning result corresponding to the raw data.

11. The machine learning method of claim 10, further comprising:
transmitting the metadata to a server; and
inputting the metadata, by the server, to the second partition that follows the first partition in the neural network.

12. The machine learning method of claim 10, wherein the activation function is ordered as a first activation function in the neural network.

13. The machine learning method of claim 10, wherein the activation function corresponds to a stepwise nonlinear function and a domain of the activation function is divided into a plurality of intervals according to a number of division, and each of the plurality of intervals corresponds to a fixed value in a range of the activation function.

14. The machine learning method of claim 13, wherein the activation function corresponds to a clipping value, and the clipping value and the number of division have a ratio, the activation function is configured to compare an input with the clipping value to generate a comparison result, and the activation function is configured to generate the metadata according to the ratio, the comparison result and the input.

15. The machine learning method of claim 13, wherein the number of division is in a range between a first value and a second value.

16. The machine learning method of claim 13, wherein the number of division is determined according to a content complexity of the raw data.

17. The machine learning method of claim 10, wherein the first partition comprises a convolution layer.

18. The machine learning method of claim 10, wherein the second partition comprises at least one of a convolution layer, a pooling layer and a fully connected layer.

19. A non-transitory computer readable medium associated with at least one instruction defining a machine learning method, wherein the machine learning method comprises:
inputting raw data to a first partition of a neural network, wherein the first partition at least comprises an activation function of the neural network and the activation function is configured to convert the raw data into irreversible metadata, and the metadata is transmitted to a second partition of the neural network to generate a learning result corresponding to the raw data.

20. The non-transitory computer readable medium of claim 19, wherein the machine learning method further comprises:
transmitting the metadata to a server; and
inputting the metadata, by the server, to the second partition that follows the first partition in the neural network.
